(19) United States
(12) Patent Application Publication
(10) Pub. No.: US 2018/0022284 A1
(43) Pub. Date: Jan. 25, 2018

(54) Vehicle Storage Rack

(71) Applicant: Barry Bessette, Harwichport, MA (US)

(72) Inventor: Barry Bessette, Harwichport, MA (US)

(21) Appl. No.: 15/214,521

(22) Filed: Jul. 20, 2016

(51) Int. Cl. B60R 9/045; B60R 9/048; B60R 9/058; B60R 9/08

(52) U.S. Cl. CPC B60R 9/045; B60R 9/08; B60R 9/048; B60R 9/058

(57) ABSTRACT

A vehicle roof rack is provided. The vehicle roof rack comprises an elongate base positionable on a roof of the vehicle. A fixed hook extends from the base, while an adjustable hook is movably attached to the base and urged by a spring, elastic, or the like towards the fixed hook. An item can be placed between the fixed and adjustable hooks and held in place on the roof.

### BACKGROUND OF THE INVENTION

### Field of the Invention

The present invention relates generally to vehicle roof storage devices. More particularly the present invention relates to a device having an extendable and retractable hook structure that can extend when in an open position, and retract over a stored item when in a closed position, holding the stored item in place.

### Description of Related Art

Vehicle roof storage is a convenient and effective way to store items that are too large to conveniently fit within a vehicle's interior cabin. For example, skis, snow boards, surf boards, kayaks and other small boats, bicycles, and the like. Existing vehicle roof storage solutions often involve complex and cumbersome racks that have various securing elements that require time and precision to secure. Other solutions include strapping down items. This strapping process can be dangerous if not done correctly, can be time consuming, cumbersome, can cause excess noise from vibration of the strap at driving speed, and can result in damage to the items from being too tightly strapped, from vibrations, friction, and the like.

Therefore, what is needed is a roof storage system that can provide simple and easy storage and removal of items on a vehicle roof safely, securely, and without damaging the items being stored.

### SUMMARY OF THE INVENTION

The subject matter of this application may involve, in some cases, interrelated products, alternative solutions to a particular problem, and/or a plurality of different uses of a single system or article.

In one aspect, a vehicle roof rack is provided. The roof rack includes an elongate body capable of attachment to a vehicle roof. A fixed hook extends upward away from the elongate body. An adjustable hook is slideably connected to the elongate body. This adjustable hook is slideable in a direction parallel to a lengthwise axis of the elongate body, allowing the adjustable hook to move towards and away from the fixed hook. A biasing spring or similar force applying device is positioned with respect to the body to urge the adjustable hook towards the fixed hook, while allowing movement of the adjustable hook away from the fixed hook.

In another aspect, a vehicle having a roof rack is provided. The vehicle has a roof on which a vehicle storage rack is attached, through any various means. Two storage racks, a front rack and a rear rack, form the vehicle storage rack system. Each of the two roof racks includes an elongate body capable of attachment to a vehicle roof. A fixed hook extends upward away from the roof from the elongate body. An adjustable hook is slideably connected to the elongate body. This adjustable hook is slideable in a direction parallel to a lengthwise axis of the elongate body, allowing the adjustable hook to move towards and away from the fixed hook. A biasing spring is positioned with respect to the body to urge the adjustable hook towards the fixed hook, while allowing movement of the adjustable hook away from the fixed hook. Upon drawing away the two adjustable hooks, an item can be placed on the elongate body adjacent to the fixed hook. When the adjustable hooks are released, the spring will draw them towards the fixed hook and the item, holding the item in place by the force applied to it, and/or by portions of the adjustable and fixed hooks passing over a top of the item.

### BRIEF DESCRIPTION OF THE DRAWINGS

FIG. 1 provides a side view of an embodiment of the present invention.

FIG. 2 provides a detail side view of an embodiment of the present invention.

FIG. 3 provides a rear view of an embodiment of the present invention mounted on a vehicle roof.

FIG. 4 provides an elevation view of an embodiment of the present invention mounted on a vehicle roof.

FIG. 5 provides a rear view of an embodiment of the present invention mounted on a vehicle roof.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention concerns a vehicle roof storage rack having a hook or similar protrusion that can be retracted to allow entry of an item, and then released to hook over the item to hold it in place at rest. The vehicle storage rack of the present invention may be attached to a roof of the vehicle in any manner, such as directly attached to the roof, removably attached to the roof, attached to an existing roof bar or bars, and the like. In varying embodiments, the vehicle storage rack of the present invention is configured to hold any number of different items that are capable of having a hook or similar structure urged against a side to hold the item in place. Examples of items that may be secured by the present invention include, but are not limited to surfboards, kayaks, bicycles, skis, snow boards, and the like.

In one embodiment, differently sized hooks may be removably attachable and swappable to an elongate base to allow for different sized and shaped items to be held by the system.

As used herein, the term hook is intended to describe not only hooked shaped items, but also any other protrusion extending from an elongate base. These protrusions may be straight, variously curved, variously angled and so on. In one example, the hook may be curved and may have one end approximately perpendicular (+/−20 degrees) to an opposite end.

A spring or similar force applying device may be positioned on, or in, an elongate base to allow a hook to be biased in a direction towards an elongate base and towards another opposing hook. The spring thereby causes an item between the two hooks to be frictionally held in place. This inward urging may be achieved by any number of different force applying devices including springs of any type, elastic or other stretchable bands such as a bungee cord, pistons, and the like. The term “spring” will be used herein to not only refer to springs, but also to any force applying device or structure capable of urging a first hook towards the second hook as described herein or otherwise.

As will be shown in the figures, typically the present invention is configured to allow a first adjustable hook to move inwardly and outwardly relative to a lengthwise axis of the elongate base. However, in alternative embodiments, both facing hooks may be movable relative to the lengthwise axis of the elongate base. For example, complementary gearing may be used to connect the hooks, such that a pushing or pulling on one hook causes movement of both hooks towards or away from each other.

In many embodiments, a shaft connects an adjustable hook to the elongate body. For example, shaft may slide inside or outside the elongate body. In another embodiment, the shaft may be positioned adjacent to the elongate body and connected to it in a slideable fashion.

As will be understood, it is common for scratchable and otherwise fragile items to be stored on vehicle roofs. As such, in some embodiments, a padding or soft material may cover all or portions of the hooks to prevent them from damaging items stored by the vehicle roof rack of the present invention.

A locking structure may be employed by the present invention to hold an adjustable hook in place to prevent its movement that may cause accidental release of an item stored therein, or to prevent damage to the device when not in use. The locking structure may be any structure capable of holding the adjustable hook in place. For example, a keyed lock may be used to prevent movement of the hook. Or, a tension or twist lock may prevent movement of the hook. Further, a pin may be insertable into a spacing to prevent movement of the hook.

In a particular embodiment, a frontal bar or other blocking element may extend from the elongate base to be positioned in front of where the item would rest in the roof rack. This frontal bar may serve as a blocking element to prevent the item from sliding forward in the event of a head on vehicle collision. A similar structure may extend to a rear of the rack.

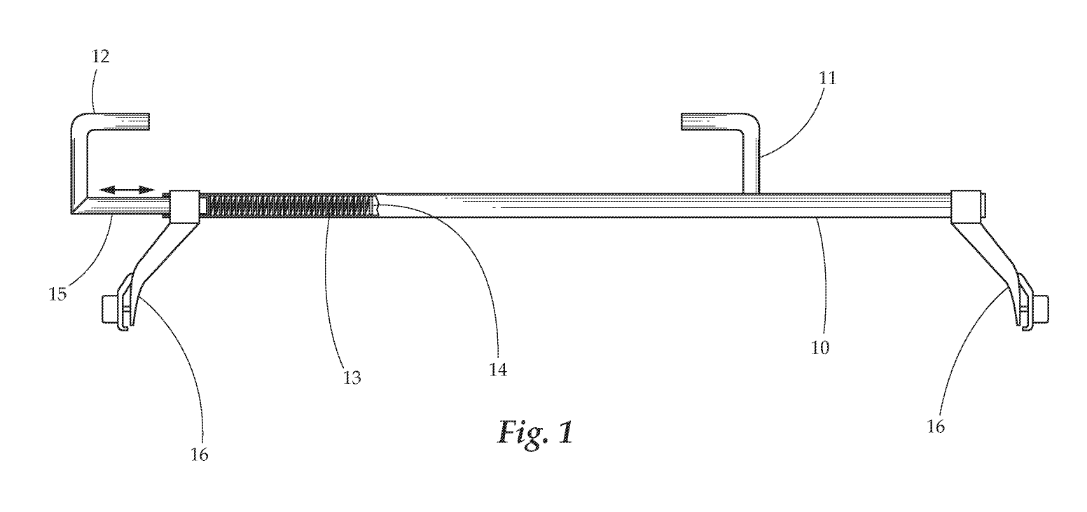

Turning now to FIG. 1, an embodiment of the present invention is provided. In this embodiment, an elongate base 10 is attachable to either a vehicle roof, or a built-in roof channel or bar via clamp 16. The clamp 16 may be any structure capable of attaching the base 10 to the roof of the vehicle. In the embodiment shown, the clamp 16 is connectable to a slot under a door of a vehicle, but it should be understood that clamp 16 may be any structure capable of attaching base to a roof or roof-mounted assembly of a vehicle. A fixed hook 11 extends upwards from the base 10. The fixed hook 11, in this embodiment, faces an adjustable hook 12. However, as noted above, in other embodiments the fixed hook 11 may vary in shape and configuration without straying from the scope of the present invention.

An adjustable hook 12 is positioned on one end of the elongate base 10. The adjustable hook 12 is movable inward and outward, as indicated by the arrow. This adjustable hook 12 is configured to allow access of an item in an extended position away from the fixed hook 11, and then once released, is urged into a closed position closer to the fixed hook 11 that clamps around the item. The adjustable hook 12, in this embodiment, faces the fixed hook 11. However, as noted above, in other embodiments the adjustable hook 12 may vary in shape and configuration without straying from the scope of the present invention.

A shaft 15 is shown in this embodiment connecting to the adjustable hook 12 and extending into the elongate base 10. The shaft 15 is connected to a biasing spring 14 positioned within an interior cavity 13 of the elongate base 10. Biasing spring 14 may be any structure capable of drawing the adjustable hook 12 inward towards the opposing fixed hook 11, and is shown in this non-limiting embodiment as a coil spring.

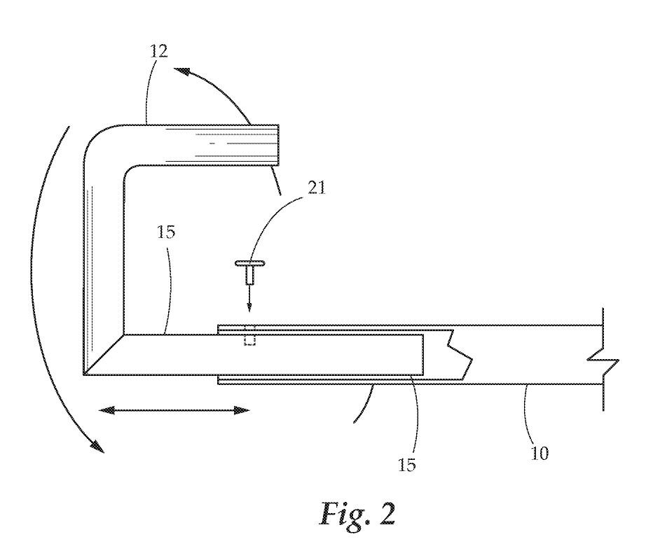

FIG. 2 shows another embodiment of the present invention in a detail view of the adjustable hook. In this embodiment, adjustable hook 12 is movable both in an inward and outward direction as indicated by the horizontal arrows. The adjustable hook 12 is also movable in a rotatable direction as indicated by the curving arrows. This rotation of the adjustable hook 12 is achieved by movement of the shaft 15 along its lengthwise axis within the elongate base 10. Radial adjustment of the adjustable hook 12 allows it to be rotated away from a holding position to allow for easy loading and unloading of the item held by the roof rack. For example, the adjustable hook 12 may be drawn away, and then rotated downward. Upon release, it stays down and out of the way for loading and unloading.

A locking structure 21, shown in this figure as a locking pin, allows the adjustable hook 12 to be held in place when desired. The pin fits within an opening in both the elongate base 10 and shaft 15, preventing their movement with respect to one another. As noted above, this locking structure 21 may be any structure capable of holding the adjustable hook 12 in place.

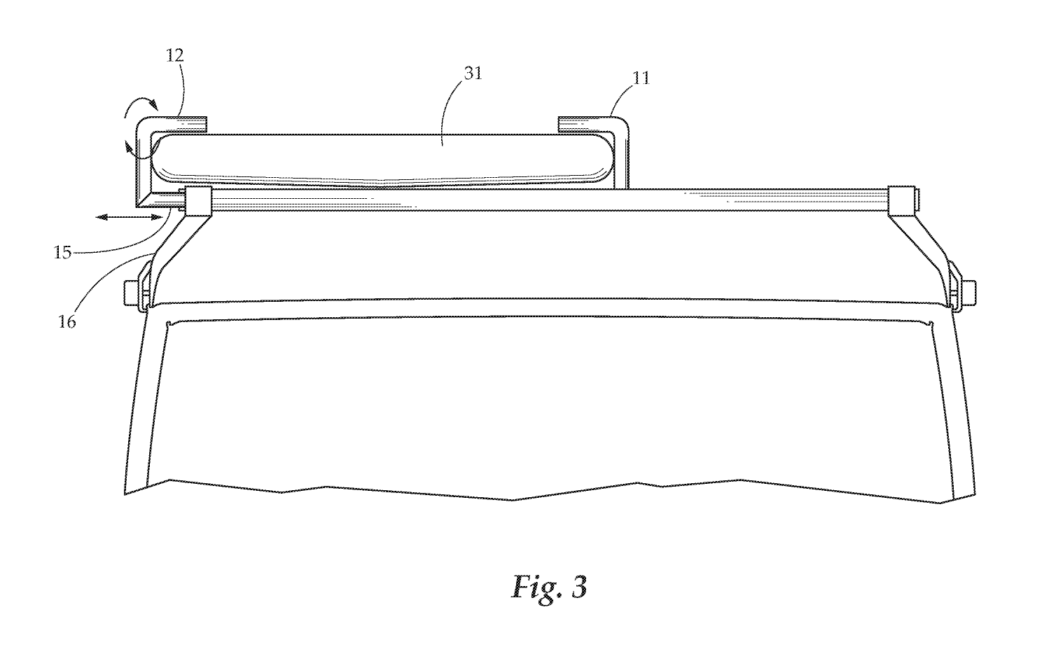

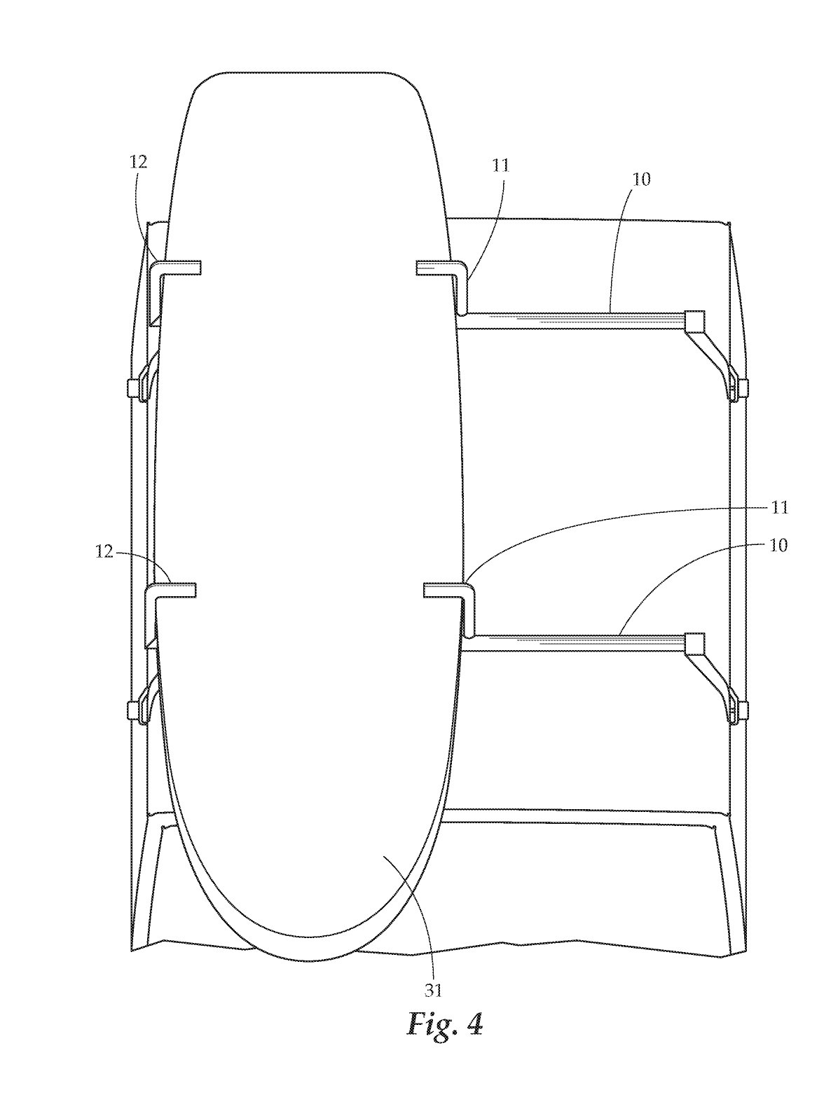

FIGS. 3 and 4 provide side and top views of an embodiment of the present invention attached to a vehicle roof holding a surfboard. As can be seen, clamp 16 attaches to the vehicles roof. Surfboard 31 is held within the vehicle roof rack by adjustable hook 12 urging against a surface, and fixed hook 11 urged against the opposing surface by the force applied to the surfboard 31 by adjustable hook 12 being biased in the closed position by the spring (not shown). Surfboard 31 is prevented from movement in all directions by the hooks 11, 12, and the frictional forces between the surfboard 31 and hooks 11, 12. As is shown in FIG. 4, typically a roof mounted vehicle storage rack system comprises two roof racks. A first roof rack is at the front, and a second is at the rear.

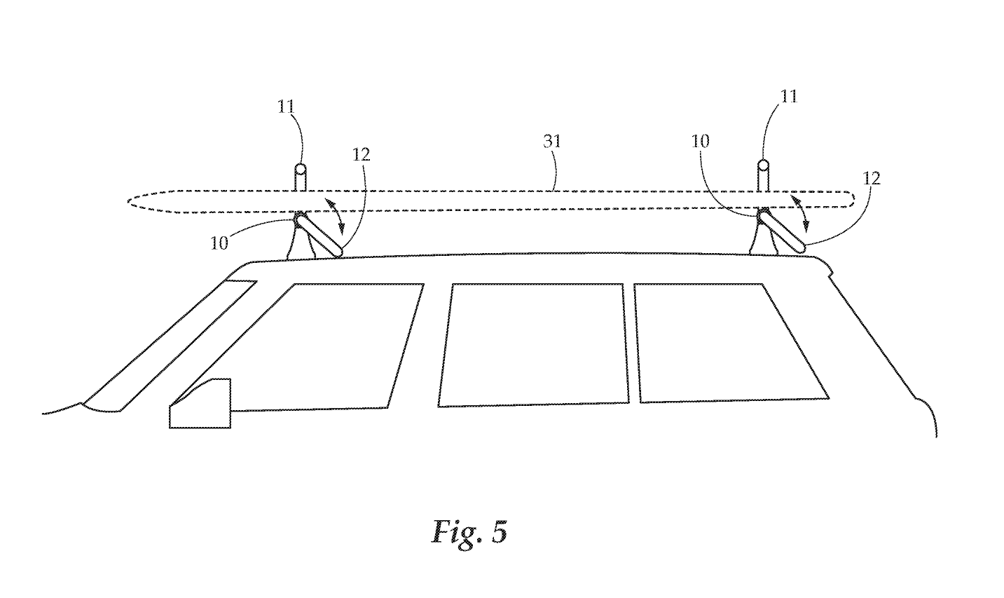

FIG. 5 provides a side view of an embodiment of the present invention attached to a roof. In this view, the rotational ability of the adjustable hook 12 is shown. In varying embodiments, this rotation may be limited to 90 degrees, 120 degrees, 180 degrees, and the like from the upward orientation. In other words, in some cases the adjustable hook may not be fully freely rotatable, but may at least be partially rotatable to move out of the way of an item to be loaded and unloaded. Here, two adjustable hooks 12 are rotated downward to an open position allowing an item, shown here as a surfboard 31 to be easily slid into and out of position on the roof rack. When the item is to be secured in place, the adjustable hook 12 is drawn outward (in this view, coming out of the page), then rotated upward to match with the fixed hook's 11 alignment, and then released such that the biasing spring (or equivalent structure) squeezes the item between the fixed hook 11 and adjustable hook 12.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A vehicle roof rack comprising:
an elongate body capable of attachment to a vehicle roof;
a fixed hook extending from a top surface of the elongate body;
an adjustable hook extending from a shaft, the adjustable hook movable with respect to the elongate body in a direction parallel to a lengthwise axis of the elongate body; and
a biasing spring positioned to urge the adjustable hook towards the fixed hook and allowing movement of the adjustable hook away from the fixed hook.

2. The vehicle roof rack of claim 1 wherein the shaft is rotatable about the lengthwise axis of the elongate body.

3. The vehicle roof rack of claim 1 wherein the adjustable hook is formed as a curving structure having a first end approximately perpendicular to a second end.

4. The vehicle roof rack of claim 1 wherein the spring is a coil spring.

5. The vehicle roof rack of claim 1 wherein the spring is an elongate elastic.

6. The vehicle roof rack of claim 1 wherein the elongate base comprises two clamps, the two clamps attachable to the vehicle roof.

7. The vehicle roof rack of claim 1 further comprising a lock in communication with at least one of the shaft and the adjustable hook, the lock configured to prevent movement of the adjustable hook in a first locked position, and to allow movement of the adjustable hook in a second unlocked position.

8. The vehicle roof rack of claim 1 further comprising a padding on at least one of the fixed hook and the adjustable hook.

9. The vehicle roof rack of claim 1 wherein the fixed hook is removable from the elongate body.

10. The vehicle roof rack of claim 1 wherein the adjustable hook and shaft is removable from the elongate body.

11. The vehicle roof rack of claim 1 wherein the shaft is slideably mounted within an interior of the elongate base.

12. The vehicle roof rack of claim 1 further comprising a surfboard held in place between the fixed hook and adjustable hook, a first side of the surfboard in contact with the fixed hook, a second side of the surfboard in contact with the adjustable hook, a force applied to the first and second sides of the surfboard by the biasing spring urging the adjustable hook against the second side.

13. A vehicle having a roof rack comprising:
a vehicle body having a roof;
a vehicle storage rack comprising two roof racks, each roof rack comprising:
an elongate body attached to the roof of the vehicle;
a fixed hook extending from a top surface of the elongate body;
an adjustable hook extending from a shaft, the adjustable hook movable movable with respect to the elongate body in a direction parallel to a lengthwise axis of the elongate body; and
a biasing spring positioned to urge the adjustable hook towards the fixed hook and allowing movement of the adjustable hook away from the fixed hook.

14. The vehicle of claim 13 wherein the shaft is rotatable about the lengthwise axis of the elongate body.

15. The vehicle of claim 13 wherein the adjustable hook is formed as a curving structure having a first end approximately perpendicular to a second end.

16. The vehicle of claim 13 wherein the spring is a coil spring.

17. The vehicle of claim 13 wherein the spring is an elongate elastic.

18. The vehicle of claim 13 wherein the elongate base comprises two clamps, the two clamps attaching the elongate base to the vehicle roof.

19. The vehicle of claim 13 further comprising a lock in communication with at least one of the shaft and the adjustable hook, the lock configured to prevent movement of the adjustable hook in a first locked position, and to allow movement of the adjustable hook in a second unlocked position.

20. The vehicle of claim 13 further comprising a surfboard held in place between the fixed hook and adjustable hook of each of the two roof racks, a first side of the surfboard in contact with the each of the two fixed hooks, a second side of the surfboard in contact with each of the two the adjustable hooks.
